(19) United States
(12) Patent Application Publication
(10) Pub. No.: US 2016/0117448 A1
(43) Pub. Date: Apr. 28, 2016

(54) SYSTEM FOR MANAGING ACCESS TO MEDICAL DATA

(71) Applicant: KONINKLIJKE PHILIPS N.V., Eindhoven (NL)

(72) Inventors: DIETER MARIA ALFONS VAN DE CRAEN, BALEN (BE); MUHAMMAD ASIM, EINDHOVEN (NL)

(21) Appl. No.: 14/895,635

(22) PCT Filed: Jun. 17, 2014
(86) PCT No.: PCT/EP2014/062609

§ 371 Date: Dec. 3, 2015

(30) Foreign Application Priority Data
Jun. 28, 2013 (EP) 13174358.5

(51) Int. Cl. G06F 19/00; G06F 21/62

(52) U.S. Cl. CPC G06F 19/322; G06F 21/6245

(57) ABSTRACT

The present application relates to a system for managing access to medical data, comprising a first module which displays data request information for requesting access to the medical data from the data provider, and a second module which obtains the data request information from the first module and requests access to the medical data from a data provider based on the obtained data request information. The first module can provide the data request information by Patient Physician displaying the data request information, for example as a quick-response (QR) code. The data request information may comprise a uniform resource locator (URL) linking to the data provider. The data provider can store the medical data locally or can retrieve the medical data from a remote source, such as a personal health record (PHR) server. In response to a data access request, the data provider may request user authentication from the patient to whom the medical data corresponds, and only provide the medical data to the second module in response to successful authorization.

### FIELD OF THE INVENTION

The present invention relates to a system for managing access to medical data, particularly in relation to sharing medical data between patients and healthcare professionals.

### BACKGROUND OF THE INVENTION

In a healthcare environment it is desirable for a patient to be able to share medical data with a doctor or other healthcare professional. For example, the medical data can include information about previous test results for the patient, and by sharing the medical data the need to repeat the tests can be avoided. An efficient medical data management system can improve the quality of care and reduce the cost of care, by allowing a doctor to spend more time interacting with the patient rather than duplicating previous work. However, to ensure privacy it is desirable for the medical data to be shared in a safe and secure manner, and in particular for the patient to be able to control who is allowed to access their medical data.

Various systems for sharing medical data are known, including Electronic Health Records (EHRs), Electronic Medical Records (EMRs), Personal Health Records (PHRs), and medical information cards. A medical information card stores medical information, for example in a memory module that can be accessed through an integrated USB connector. An EHR or EMR is an electronic repository of medical record information that is generated and maintained by an institution such as a hospital, integrated delivery network, clinic, or physician office. A PHR differs in that it is an electronic repository of medical record information that is maintained by an individual patient, as opposed to a medical institution.

To share data from a PHR, users must complete a number of steps. Typically, to allow patients to share data from a PHR, a healthcare organization can create a PHR-integrated offline application in which registered patients can log in and allow exchange of health information with the PHR. The application can also have a login window for a physician to log in to access patient data from the PHR. The physician can log into the application and choose the particular patient using a unique patient ID. The application will pull the data from the corresponding PHR record and render it to the physician.

### SUMMARY OF THE INVENTION

It is an object of the invention to provide a system for accessing patient data which substantially alleviates or overcomes the problems mentioned above.

According to an aspect of the invention, there is provided a system for managing access to medical data corresponding to a patient, the system comprising: a data provider arranged to provide access to the medical data; a first module arranged to provide data request information for requesting access to the medical data from the data provider; and a second module arranged to obtain the data request information from the first module, and to request access to the medical data from the data provider based on the obtained data request information. The first module and second module can, for example, be embodied as physically separate devices, or as software applications executed by the same physical device.

This arrangement provides the advantage that medical data can easily be shared without having to go through the time-consuming registration and set-up procedure required by a conventional PHR application. To share data a user only has to provide a doctor with the necessary data request information, for example by displaying the data request as a Quick-Response (QR) code that the doctor can scan using a smart phone or tablet computer. The use of data request information also has the advantage that the medical data can be stored anywhere, meaning that the system can easily be integrated with existing record systems such as PHRs, EHRs and EMRs.

The data request information can comprise a direct link, for example in the form of a Universal Resource Locator (URL). Alternatively, in some embodiments the data request information can be a unique identifier assigned to the medical data. For example, different identifiers can be assigned to medical data for different patients, and different identifiers can be assigned to predefined subsets of medical data for the same patient. Each identifier can be stored in a database and cross-referenced to information identifying a known location of the corresponding medical data. The second module can obtain the identifier from the first module, and query the database to retrieve the information identifying the known location of the corresponding medical data, in order to request the medical data from the data provider. The database can be stored locally in the second module or can be accessed remotely. As a further alternative, in some embodiments the second module can request the medical data by transmitting the unique identifier to the data provider, and the data provider can retrieve the medical data by querying a database as described above. Alternatively, instead of a unique identifier the data request information could identify a subset of a patient's medical data in another way. For example, the data request information could include a query to request a specific subset such as a request for family history data relating to information about disorders suffered by direct relatives of the patient, or a request for recent patient data comprising medical data for the patient from a recent time period (e.g. from 6 months ago up to present day).

In some embodiments, the first module is arranged to include one or more access parameters in the data request information, the access parameters comprising parameters relating to how the medical data is to be shared with the second module, the second module is arranged to transmit the access parameters to the data provider when requesting the medical data, and the data provider is arranged to control access to the medical data by the second module based on the access parameters. The one or more access parameters can include: a time period parameter defining a time period during which the second module is allowed to access the medical data; and/or data element parameters identifying which ones of a plurality of data elements included in the medical data can be accessed by the second module.

The access parameters can be used to control the manner in which the second module is permitted to access the medical data. For example, a user can set the access restrictions so that only certain data elements of the medical data are shared. This feature gives a user granular control over the data being shared.

In some embodiments, the data request information comprises a Uniform Resource Locator URL linking to the data provider, and the second module is arranged to request the medical data by navigating to the URL. This arrangement can allow a device which includes the second module to access medical data through a web-based application using any web browser. The use of a web-based application can enable medical data from different types of health record systems to be accessed without having to install any special software on the device.

In some embodiments, the first module is arranged to display the data request information, for example as a Quick-Response (QR) code. This approach allows the data request information to be obtained by any device which includes a camera and has the ability to process the captured image to detect the data request information, for example using a QR reader application to detect and decode the data request information when displayed as a QR code.

In some embodiments, the data provider is arranged to respond to the request from the second module to access the medical data by requesting authentication from the patient to whom the requested medical data corresponds, and is arranged to provide the requested medical data to the second module in response to successful authentication. The use of authentication means that security of the medical data is not compromised if the device including the first module is lost or stolen, since a third party cannot access the medical data without the necessary authentication information, for example a username and password. In some embodiments, the data provider is arranged to request authentication by transmitting an authentication request to the first module, receiving authentication information from the first module, and comparing the received authentication information to known authentication information for the patient to determine whether authentication is successful. This avoids any risk of the authentication information being intercepted by the second module, since the second module does not participate in authentication.

In some embodiments, the data request information includes authenticating device information identifying the first module or the second module, and the data provider is arranged to request authentication from the first module or the second module identified by the authenticating device information. This can allow authentication that can be performed even when the first module is not capable of providing authentication information, for example when the first module does not include any user interface through which authentication information could be inputted.

In some embodiments, after receiving the request for the medical data from the second module, the data provider is arranged to determine whether the data request information has already been used in a previous data request, and to only provide the requested medical data to the second module if it is determined that the data request information has not been used in a previous data request.

In some embodiments, the first module is arranged to obtain a protected token and include the protected token in the data request information, the protected token comprising a token that has been protected using a cryptographic key, and the data provider is arranged to receive the encrypted token from the second module, process the protected token using an expected cryptographic key, and if is the token is successfully obtained using the expected cryptographic key, determine that the data request information has not been used in a previous data request if the expected cryptographic key has not previously been used.

In some embodiments, the first module is arranged to obtain the protected token by obtaining a token and then protecting the token using the cryptographic key. For example, the first module can protect the token by applying encryption using an encryption key. In other embodiments, the first module is arranged to select the protected token from a plurality of protected tokens. For example, the first module can be installed with a list of predetermined protected tokens, for instance encrypted tokens which have already been encrypted using an encryption key. Although encryption is described in the above-mentioned examples, in other embodiments other types of cryptographic protection such as authentication may be applied instead of, or in addition to, encryption.

In some embodiments, the data provider is arranged to obtain the expected cryptographic key by applying a cryptographic algorithm to a previous cryptographic key, which is a cryptographic key that was used in the most recently received data request prior to the current data request. In some embodiments, the cryptographic algorithm is a hash function that is known to both the data provider and the first module, so that the data provider and the first module can both obtain the same cryptographic key from a previous cryptographic key.

In some embodiments, the data provider is arranged to provide access to the medical data by retrieving the medical data from one or more remote medical record servers, and transmitting the retrieved medical data to the second module. By doing this, the system can be easily integrated with existing medical record systems. For example, the one or more remote medical record servers can include one or more Personal Health Record PHR servers, and/or one or more Electronic Health Record EHR servers, and/or one or more Electronic Medical Record servers.

In some embodiments, components of the system such as the data provider and the first module or the second module can be embodied in a single physical device. In other embodiments, various components of the system can be distributed among two or more devices.

According to another aspect of the invention, there is provided an apparatus for use as a first module in the system, the apparatus comprising: a data request information generator arranged to generate data request information for requesting access to the medical data from the data provider; and a data request information providing module arranged to provide the generated data request information to the second module.

According to another aspect of the invention, there is provided a control method of the first module, the method comprising: generating data request information for requesting access to the medical data from the data provider; and providing the data request information to the second module.

According to another aspect of the invention, there is provided an apparatus for use as the data provider, the apparatus comprising: a controller arranged to retrieve medical data corresponding to a patient; an authentication module arranged to request authentication; and a communication module arranged to communicate with a first module and a second module, wherein in response to a request received through the communication module from the second device to provide access to the medical data, the controller is arranged to control the authentication module to request authentication from the first module or the second module through the communication module and determine whether authentication was successful, and in response to successful authentication the controller is arranged to provide access to the requested medical data to the second module through the communication module.

According to another aspect of the invention, there is provided a method of providing medical data, the method comprising: receiving a request to provide access to the medical data; requesting authentication from a first module or a second module, in response to the request for the medical data; determining whether authentication was successful; and in response to successful authentication, providing access to the requested medical data. According to another aspect of the invention, there is provided an apparatus for use as a second module in the system, the apparatus comprising: a data request information detector arranged to obtain data request information from the first module; a communication module for communicating with the data provider; and a controller arranged to control the communication module to request access to the medical data from the data provider based on the obtained data request information.

According to another aspect of the invention, there is provided a method for requesting access to medical data at a second module, the method comprising: obtaining data request information from a first module, the data request information comprising information for requesting access to the medical data from the data provider; and requesting access to the medical data from the data provider based on the obtained data request information. According to another aspect of the invention, there is also provided a computer-readable storage medium arranged to store a computer program which, when executed by a device, causes the device to perform any of the methods described herein.

These and other aspects of the invention will be apparent from and elucidated with reference to the embodiments described hereinafter.

### BRIEF DESCRIPTION OF THE DRAWINGS

Embodiments of the invention will now be described, by way of example only, with reference to the accompanying drawings, in which:

FIG. 1 schematically shows a system for managing access to medical data corresponding to a patient, according to an embodiment of the invention;

FIG. 2 schematically shows an apparatus for use as the first device in the system of FIG. 1, according to an embodiment of the invention;

FIG. 3 schematically shows an apparatus for use as the second device in the system of FIG. 1, according to an embodiment of the invention;

FIG. 4 schematically shows a system for managing access to medical data using authentication, according to an embodiment of the invention;

FIG. 5 schematically shows an apparatus for use as the data provider in the system of FIG. 4, according to an embodiment of the invention;

FIG. 6 shows a flow diagram explaining the operation of the system of FIG. 4;

FIG. 7 schematically shows a system for managing access to medical data from a plurality of personal health records (PHRs), according to an embodiment of the invention;

FIG. 8 shows a flow diagram explaining a method of generating and providing data request information, according to an embodiment of the invention;

FIG. 9 shows a flow diagram explaining a method of managing access to medical data, according to an embodiment of the invention; and

FIG. 10 shows a flow diagram explaining a method of selecting a device to perform authentication, according to an embodiment of the invention.

### DETAILED DESCRIPTION OF THE EMBODIMENTS

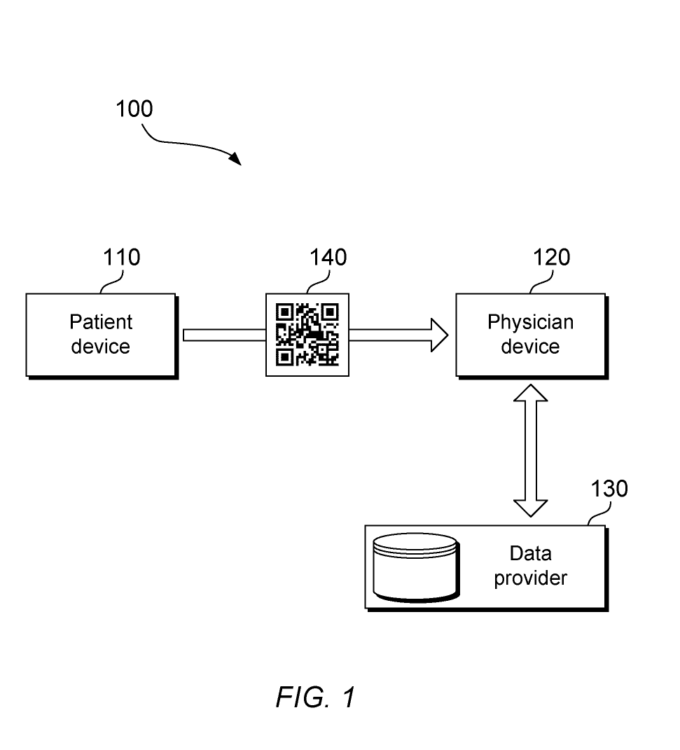

FIG. 1 schematically shows a system for managing access to medical data corresponding to a patient, according to an embodiment of the invention. The system can be used to allow a physician to access the patient's medical data, and may be referred to as a healthcare support system.

The system 100 comprises a first device 110, a second device 120, and a data provider 130. The data provider 130 is arranged to provide the medical data to the second device 120. The first device 110 can be used to share medical data, and will hereinafter be referred to as a ‘patient device’. The second device 120 can be used to view medical data shared by the patient, and will hereinafter be referred to as a ‘physician device’. The medical data can be stored locally or can be accessed from a remote location by the data provider 130. For example, the data provider 130 can retrieve the medical data from one or more PHRs over the Internet. In some embodiments, which will be described in more detail below, the data provider 130 may require patient authentication before providing access to the medical data.

The patient device 110 is arranged to display data request information for use in accessing the medical data through the data provider 130. In the present embodiment the data request information comprises a Uniform Resource Locator (URL) which links to the data provider 130. In addition, the data request information further comprises a data request token for requesting the medical data from the data provider 130. The data request token is provided as a URL parameter to be passed to the data provider 130.

The patient device 110 can display the data request information on a screen, and can for example be a smart phone, tablet, general purpose computer or any other suitable apparatus. In the present embodiment the patient device 110 is a smart phone, and is arranged to display the data request information as a quick-response (QR) code 140, but in other embodiments the data request information can be displayed in a different format, for example as a barcode or as plain text.

In other embodiments the patient device 110 can display the data request information on any surface, which may not necessarily be a screen. For example, in some embodiments the patient device 110 can be a wearable item, such as a bracelet, in which the data request information is engraved or printed onto a surface. Furthermore, in other embodiments the data request information may not be displayed but may be transferred from the patient device to the physician device using another suitable method, such as Radio-Frequency Identification (RFID) or other types of Near-Field Communication (NFC) method.

The physician device 120 is arranged to detect the displayed data request information. The physician device 120 is further arranged to access the medical data through the data provider 130 based on the detected data request information. In the present embodiment, since the data request information is displayed as a QR code 140 the physician device 120 is arranged to obtain the data request information by capturing an image of the patient device 110, processing the captured image to detect the QR code 140, and decoding the QR code 140 to obtain the data request information. In another embodiment, the data request information is displayed as a barcode and the physician device 120 is arranged to detect the displayed data request information using a barcode reader. In the present embodiment the physician device 120 is a smart phone, but in other embodiments the physician device 120 can be a tablet, general purpose computer or any other suitable apparatus.

As described above, in the present embodiment the data request information comprises a Uniform Resource Locator (URL) linking to the data provider 130, although in other embodiments a different format other than a URL could be used to link to the data provider 130. To access the medical data, the second device 120 is arranged to navigate to the URL through a web browser application, with the result that the web browser application requests a resource specified in the URL from the data provider 130. The URL may include a path which identifies the medical data being requested, for example by specifying a directory corresponding to the patient whose medical data is being requested. Alternatively, the medical data being requested can be identified in another manner, for example by a query string included in the URL which will be passed to software running on the data provider 130.

The physician device 120 and the data provider 130 can be arranged to communicate over any wired or wireless connection, for example a Bluetooth connection or Wireless Local Area Network (WLAN) connection. The data provider 130 can be embodied as a standalone apparatus separate from the patient device 110 and the physician device 120. Alternatively, in some embodiments the data provider 130 can be embodied in the same physical apparatus as the patient device 110 or physician device 120. For example, when the patient device 110 is a smart phone the data provider 130 can be embodied as a software application installed on the patient device 110, and the physician device 120 can communicate with the patient device 110 to access the medical data through the data provider 130.

By displaying the data request information, the patient device 110 allows a user, for example a patient or a carer of the patient, to control access to the patient's stored medical data. For example, to allow a doctor to access the stored medical data, a patient can show the displayed data request information to the doctor, who can scan the displayed data request information using the physician device 120. The physician device 120 then uses the scanned data request information to access the medical data. The system 100 can securely manage access to a patient's medical data, because the physician device 120 is unable to access the medical data without line-of-sight visibility of the patient device 110 in order to detect the displayed data request information.

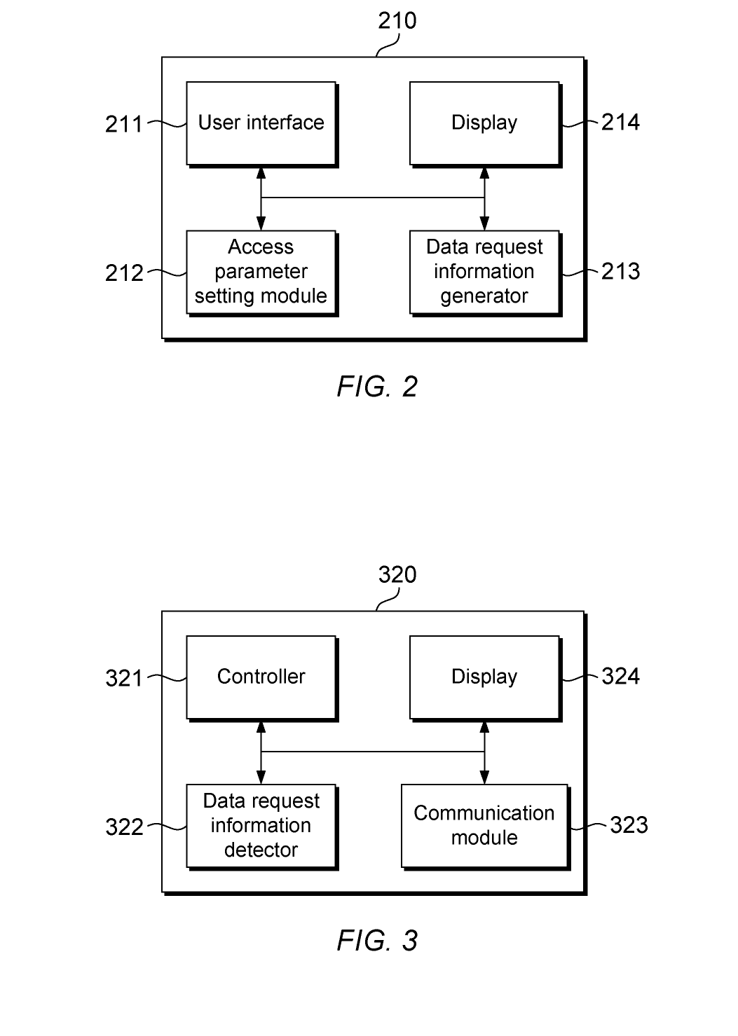

FIG. 2 schematically shows an apparatus for use as the patient device in the system of FIG. 1, according to an embodiment of the invention. The apparatus 210 comprises a user interface 211, an access parameter setting module 212, a data request information generator 213, and a display 214.

The user interface 211 can receive user input selecting one or more access parameters relating to how medical data should be shared with a second device. This allows a user to define the extent to which the medical data will be shared with the second device. Examples of access parameters that can be selected by user input include, but are not limited to, a time period during which the second device is allowed to access the medical data, and data element restrictions. Specifically, the medical data can include a plurality of data elements, and a user can set the data element restrictions to control which of the data elements may be accessed by the second device.

The access parameter setting module 212 is arranged to send the defined access parameters to the data request information generator 213, which includes the access parameters in the generated data request information. The generated data request information including the access parameters is then displayed on the display 214.

In the present embodiment, the data request information comprises a URL which links to the data provider. As described above with reference to FIG. 1, the form of the URL indicates to the data provider 130 which medical data is being requested by the second device. Also, in the present embodiment the apparatus 210 includes software for converting the data request information to a QR code. Any suitable QR code generator can be used for this purpose. The data request information is then displayed on the display 214 as the QR code.

Although in the present embodiment the apparatus 210 includes a display for providing the data request information to a second device, in other embodiments the data request information may be provided using a different method, for example NFC. In general terms, the patient device can comprise any suitable data request information providing module, which could for example be a display as shown in FIG. 2, an RFID transmitter, or a network interface module. The invention is not limited to these types of data request information providing modules, which are described by way of example.

FIG. 3 schematically shows an apparatus for use as the physician device in the system of FIG. 1, according to an embodiment of the invention. The apparatus 320 comprises a controller 321, a data request information detector 322, a communication module 323, and a display 324. The apparatus 320 can use the communication module 323 to communicate with the data provider, for example over a network connection. In the present embodiment the communication module 323 is a WLAN module, but in other embodiments a different communications protocol may be used.

The controller 321 controls the data request information detector 322 to detect the data request information displayed on the patient device. In the present embodiment the data request information is displayed in the form of a QR code, and the data request information detector 322 comprises a camera for capturing an image of the patient device. The image capture process can be controlled by a user in a conventional manner. Once an image has been captured, the apparatus processes the image to detect and decode the QR code, to obtain the data request information. For this purpose, a conventional QR code reader application can be installed on the apparatus 320 or a dedicated hardware QR code processor could be provided.

Although in the present embodiment the data request information detector is a camera, it will be appreciated that different types of data request information detector may be used in other embodiments, according to the method used by the patient device to provide the data request information to the second device. For example, the data request information detector can be an RFID receiver arranged to receive the data request information as an RFID signal, or a network interface module arranged to receive the data request information over a network. The invention is not limited to these types of data request information detectors, which are described by way of example.

Once the data request information has been obtained, the controller 321 requests the medical data from the data provider based on the data request information, through the communication module 323. The requested medical data will then be received from the data provider through the communication module 323, assuming that any necessary authentication procedures and/or access restrictions are satisfied. The controller 321 controls the display 324 to display the received medical data. Although in the present embodiment the medical data is sent over the same communications link as the data request, in other embodiments the physician device 320 can receive the medical data over a different communications link.

Apparatus such as the one shown in FIG. 3 can be used to quickly and easily access medical data for a patient simply by scanning the data request information displayed on the patient device.

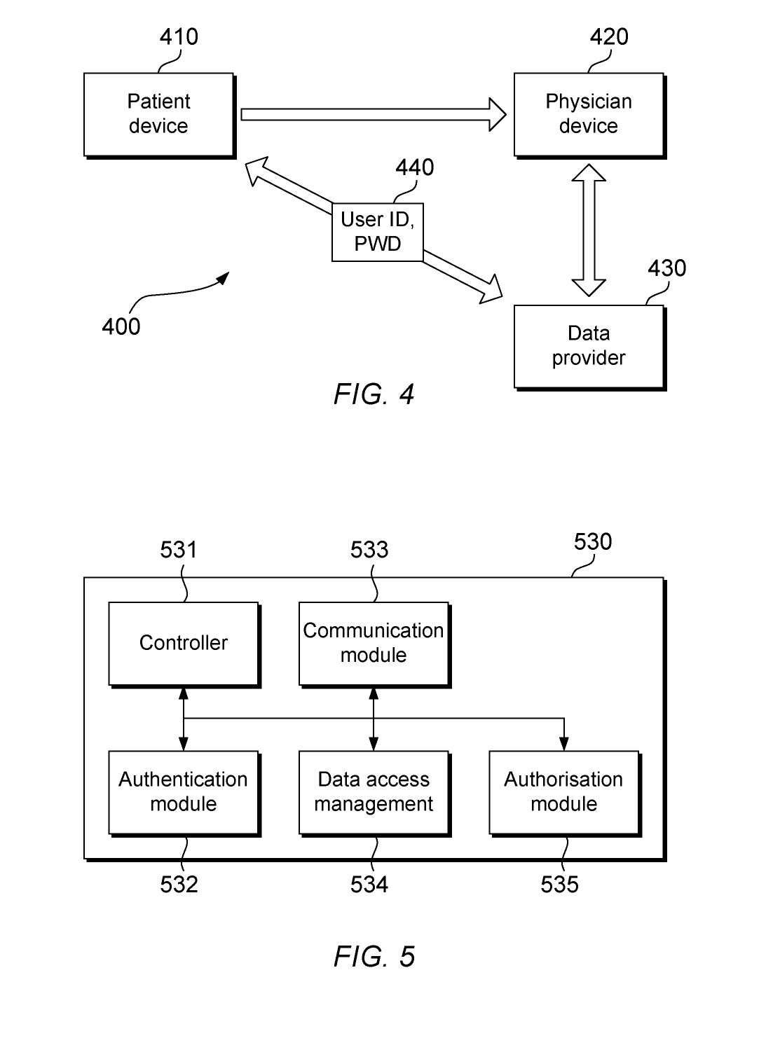

FIG. 4 schematically shows a system for managing access to medical data using authentication, according to an embodiment of the invention. The system 400 comprises a patient device 410, physician device 420, and a data provider 430. The system 400 is similar to the one of FIG. 1, with the added feature that the data provider is arranged to request authentication from the patient before providing the requested medical data to the physician device 420.

The patient device 410 can display data request information, and the physician device 420 can detect data request information displayed by the patient device 410 and request medical data from the data provider 430, using any of the approaches described above. When the data provider 430 of the present embodiment receives a request for medical data from the physician device 420, the data provider 430 responds by requesting authentication from the patient to whom the requested medical data corresponds. In the present embodiment, as shown in FIG. 4, the data provider 430 responds to the data access request from the physician 420 device by transmitting an authentication request to the patient device 410. The patient device 410 receives the authentication request and prompts a user to enter authentication information, for example a user identifier (ID) and password (PWD). After the authentication information has been inputted, the patient device 410 transmits the authentication information to the data provider 430. Authentication methods are known and a detailed description will be omitted to maintain brevity. However, in brief, the data provider 430 is arranged to compare the received authentication information to known authentication information for the patient, and determine that authentication is successful if the received authentication information matches the known authentication information. The data provider 430 is further arranged to respond to successful authentication by providing the requested medical data to the physician device 420.

In other embodiments different authentication methods can be used. For example, authentication can be carried out at the patient device 410 instead of the data provider 430, by comparing the input authentication information to the known authentication information at the patient device 410. By doing this, it is not necessary to transmit the authentication information to the data provider 430. Instead, the patient device 410 only has to transmit the result of the authentication to the data provider 430. This approach may be more secure because there is no risk of authentication information being compromised if the transmission is intercepted.

Although in the present embodiment the user authorized to provide authentication is the patient to whom the requested medical data corresponds, in other embodiments another user may be allowed to authorize the data request, instead of or in addition to the patient. As one example, a break-glass procedure can be implemented in embodiments of the invention. In the event that the patient is unable to authorize a data request, for example if the patient is incapacitated due to injury or illness, a certified healthcare provider can be used to override the normal authorization procedure to ensure that the medical data can still be accessed. The break-glass procedure may only provide access to a predefined subset of the medical data, including the most important data for use in emergency situations. Access via the emergency account should be restricted and monitored by auditing procedures to ensure that the break-glass procedure is only used in genuine emergencies.

In the present embodiment the data provider 430 transmits an authentication request to the patient device 410, but the invention is not limited to this approach. For example, in other embodiments the authentication request can be transmitted to the physician device 420 instead. Performing authentication at the physician device 420 may be appropriate when the patient device 410 is unable to perform authentication, for instance when the patient device 410 does not have receive or transmit capabilities, and/or does not include a user interface for inputting authentication information.

In some embodiments, the patient device 410 can be arranged to display data request information which includes authenticating device information identifying the patient device 410 or the physician device 420. The physician device 420 then includes the authenticating device information in the data request transmitted to the data provider 430, and the data provider 430 requests authentication from the device that is identified by the authenticating device information. This approach allows the patient device to specify whether authentication should be performed at the patient device or at the physician device. Therefore if the patient device does not have the ability to participate in authentication, the patient device can use the authenticating device information to signal to the data provider that authentication should be performed by the physician device instead.

FIG. 5 schematically shows an apparatus for use as the data provider in the system of FIG. 4, according to an embodiment of the invention. As shown in FIG. 5, the apparatus 530 comprises a controller 531, authentication module 532, communication module 533, data access management module 534, and authorization module 535.

The controller 531 is arranged to receive a request for medical data through the communication module 533. In the present embodiment, the request includes a token for authorizing the data request, and the authorization module 535 is arranged to validate the received token in order to determine whether to allow the data request.

In response to the token being successfully validated by the authorization module 535, the controller 531 controls the authentication module 532 to perform authentication before providing the requested data. The authentication module 532 transmits an authentication request to the patient device through the communication module 533, as described above with reference to FIG. 4. The authentication module 532 receives authentication information through the communication module 533, compares the received authentication information to known authentication information for an authorized user, which in the present embodiment is the patient to whom the requested data corresponds, and determines that authentication is successful if there is a match. In some embodiments the authentication module 532 is also arranged to authenticate the user of the requesting device (i.e. the physician device), for example using a Security Assertion Markup Language (SAML) token or a Public-Key Infrastructure (PKI) certificate to confirm that the user is a medical professional.

In response to successful authentication, the controller 531 retrieves the requested medical data by using the data access management module 534 to obtain the medical data from the appropriate data source, for example a PHR, and transmits the medical data to the physician device through the communications module 533. The data access management module 534 can be configured to operate with a plurality of different medical data sources, including various PHRs, EHRs and EMRs.

In the present embodiment the data request, authentication request, authentication information and medical data are sent over the same communications link, but in other embodiments the communication module 533 can be arranged to utilize two or more separate communications links. For example, the communication module 533 can communicate with a patient device over a Bluetooth connection to perform authentication, and can send medical data to a physician device over a WLAN connection.

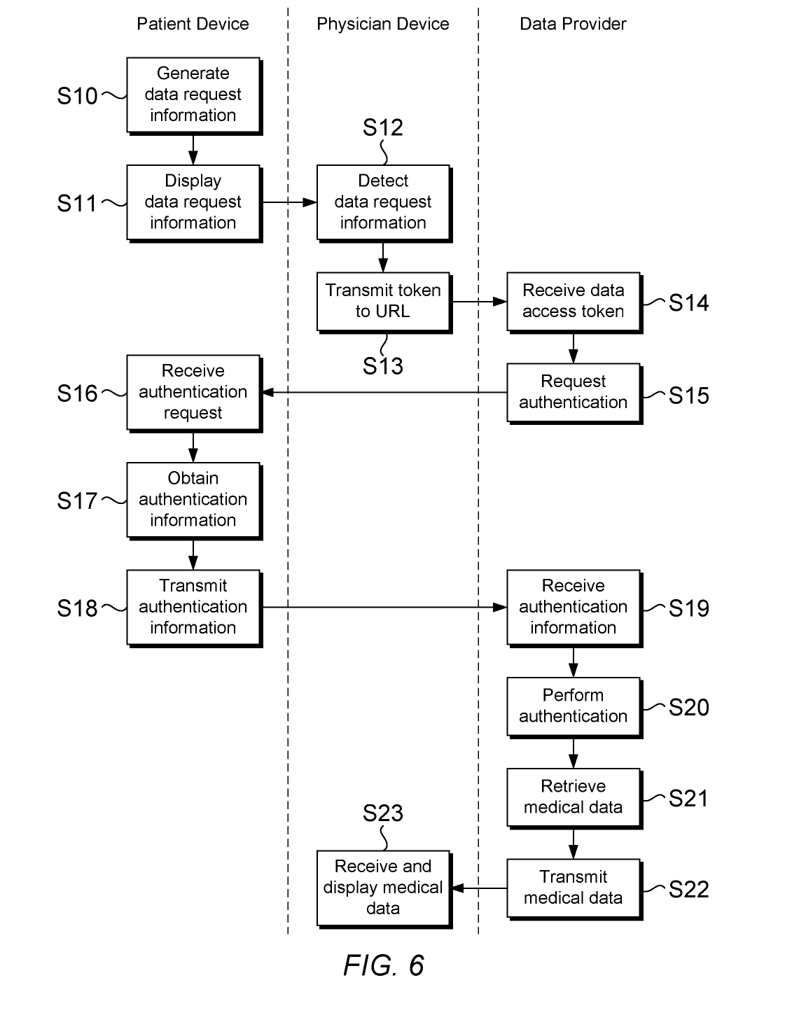

FIG. 6 shows a flow diagram explaining the operation of the system of FIG. 4. The flow diagram illustrates steps performed at the patient device 410, the physician device 420, and the data provider 430.

First, in step S10, the patient device 410 generates data request information. Depending on the embodiment, the data request information may include other information such as access parameters, authenticating device information and/or a single-use code to prevent the physician device 420 from re-using the data request information in subsequent data requests. In the present embodiment the data request information comprises a URL and a data request token as a URL parameter, but in other embodiments a different format may be used.

Then, in step S11, the generated data request information is displayed on the patient device 410. In the present embodiment the data request information is displayed as a QR code, and step S11 includes the step of converting the generated URL into a QR code.

Next, in step S12 the physician device 420 detects the displayed data request information. In the present embodiment this step involves capturing an image of the patient device 410 and processing the image to detect and decode the QR code, but as explained above, other methods of detecting the data request information can be used in other embodiments. Then, in step S13 the physician device 420 transmits a data access request to the data provider 430 to request access to the medical data, by navigating to the URL and transmitting the data request token included in the data request information.

Then, in step S14 the data access request including the data request token is received by the data provider 430. When the data request information is a URL including other parameters such as access parameters, authenticating device information and/or a single-use code, these other parameters will be received in the data access request and are therefore available to the data provider 430.

Next, in step S15 the data provider 430 requests authentication from the patient device 410, which receives the authentication request in step S16. In step S17 the patient device 410 obtains authentication information such as a user ID and password, which could be stored in the patient device 410 or could be obtained by prompting a user to enter the authentication information through a user interface. Then, the authentication information is transmitted by the patient device 410 in step S18 and received by the data provider 430 in step S19. In step S20 the data provider 430 checks whether authentication is successful by comparing the received authentication information to known authentication information for an authorized user, which in the present embodiment is the patient to whom the requested medical data corresponds.

In response to successful authentication, the requested medical is retrieved in step S21 and transmitted to the physician device 420 in step S22, which receives and displays the medical data in step S23.

The method of FIG. 6 can facilitate quick and easy sharing of medical data between a patient and a doctor through the use of data request information, which can be scanned by the physician device 420. At the same time, the use of an authentication mechanism ensures that the medical data cannot be accessed without explicit authorization from the patient. This can provide additional security in the event that the patient device 410 is lost or stolen.

Although in the present embodiment the data provider 430 requests authentication from the patient device 410 in step S15, in another embodiment the data provider 430 requests authentication from the physician device 420 in step S15. It will be understood that in this other embodiment, authentication steps S16, S17 and S18 will be performed at the physician device 420. The data request information can include device authentication information which identifies the device at which authentication is to be performed, and which is passed to the data provider 430 in the data request. Furthermore, as described above the step of determining whether authentication has been successful (S20) can be performed at the patient device 410 or physician device 420, meaning that in steps S18 and S19 the authentication result is transmitted and received instead of the authentication information.

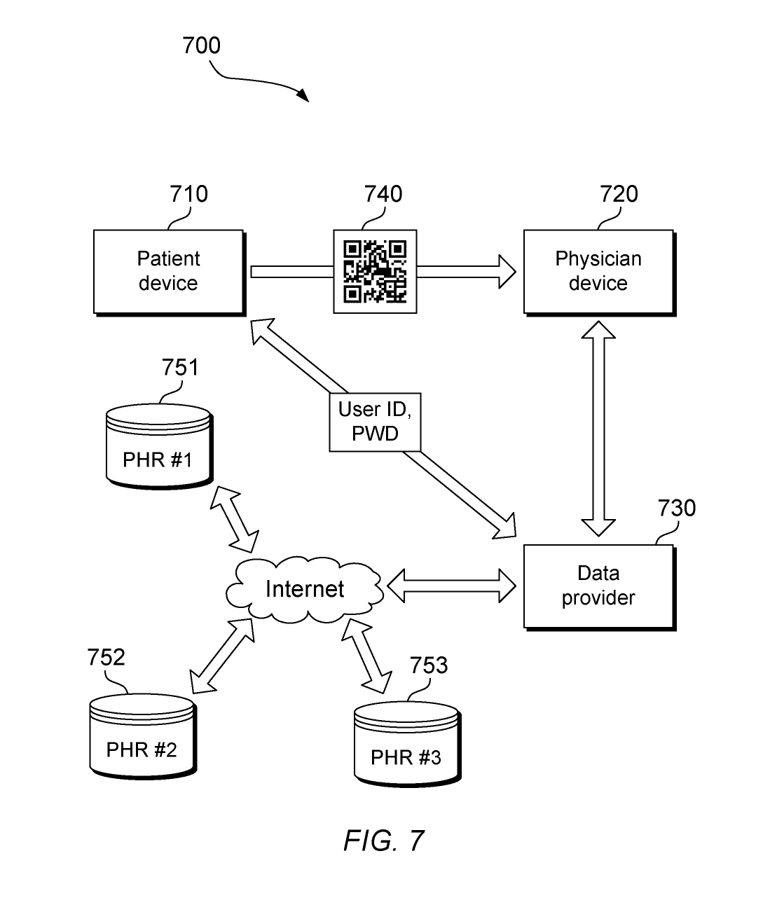

FIG. 7 schematically shows a system for managing access to medical data from a plurality of personal health records (PHRs), according to an embodiment of the invention. Many aspects of the system 700 are similar to corresponding aspects of the systems shown in FIGS. 1 and 4, and a detailed description of similar parts will be omitted here to maintain brevity.

The system 700 of the present embodiment comprises a patient device 710, physician device 720, data provider 730, and first, second and third PHRs 751, 752, 753. In response to a request for medical data for a particular patient, the data provider 730 is arranged to retrieve data for the identified patient from the first, second and third PHRs 751, 752, 753. In some embodiments, medical data for the patient may be stored in each one of the PHRs under the same patient identifier. In other embodiments, different ones of the PHR systems 751, 752, 753 may use different patient identifiers for the same patient. In such embodiments, to access medical data for the same patient the data provider 730 can be arranged to store a cross-reference of the different patient identifies that the different PHR systems 751, 752, 753 use for the same patient. Alternatively, the data provider 730 can retrieve patient identification information, which may for example include a name, date of birth, nationality, and/or address, and query each PHR 751, 752, 753 to retrieve medical data for a patient matching the retrieved identification information.

Embodiments such as the one of FIG. 7 can allow a patient to easily share medical data from a plurality of diverse record systems, such as PHRs, EMRs and EHRs. The data provider 730 can retrieve data from the systems and provide the data to the physician device 720 in a transparent manner. By making use of data request information 740 which links to the medical data through a data provider 730, the physician device 720 does not need to have separate software installed to access each individual record systems 751, 752, 753. The data request information 740 allows data retrieval to be managed by the data provider 730 rather than the physician device 720.

Although three PHRs are illustrated in FIG. 7, in other embodiments any number of one or more PHRs may be accessed through the data provider 730. Instead of, or in addition to, accessing data from PHRs, the data provider 730 may access other types of medical record system including one or more EMRs and one or more EHRs.

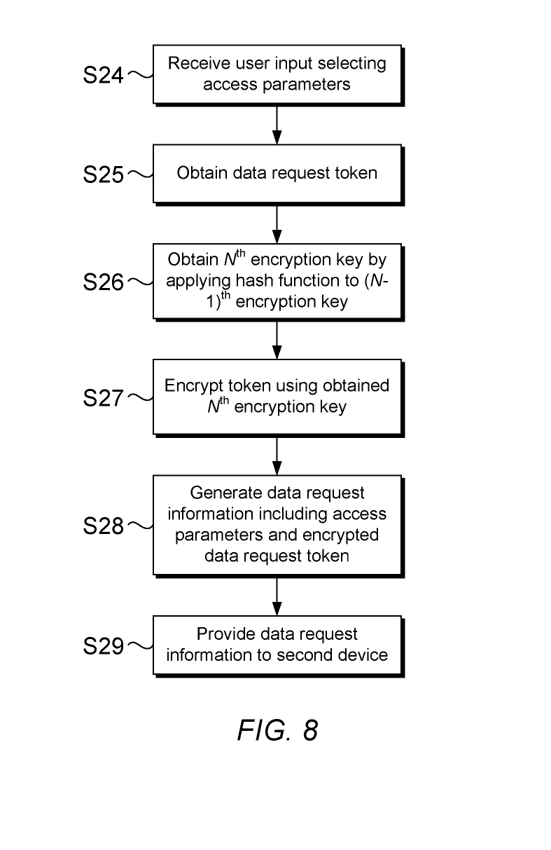

FIG. 8 shows a flow diagram explaining a method of generating and providing data request information, according to an embodiment of the invention. The method can be used by the patient device in any of the embodiments described above.

In step S24 the patient device receives user input selecting one or more access parameters to control how the medical data is shared with the second device. This allows a user to customize the data-sharing process, for example by selecting to share data for a specified time period (e.g. one day, one week etc.) and/or by selecting only specific data elements to be shared from amongst a plurality of data elements included in the medical data.

In the present embodiment the data request information comprises a URL, and the access parameters can be included in the data request information in the form of one or more query strings to be appended to the URL. In this way, the access parameters will automatically be passed to the data provider in a data request when the physician device loads the URL in a web browser application. It will be appreciated that other formats for the access parameters can be used in other embodiments.

Then, in step S25 the patient device obtains a data request token, for example by retrieving one of a plurality of predetermined data request tokens or by generating a new token using a predetermined algorithm.

Next, in step S26, the patient device obtains an encryption key (K) for encrypting the token. In the present embodiment the current encryption key is obtained by applying a predetermined hash function to the previous encryption key that was used when encrypting a token in the most recently generated data request information. In general terms, the current encryption key can be referred to as the N^{th} encryption key (K_{N}), and the previous encryption key can be referred to as the (N−1)^{th} encryption key (K_{N-1}).

The initial encryption key (K₁), from which the second and subsequent encryption keys are derived by repeated application of the hash function, is a secret key shared between the patient device and the data provider. For example, the patient device and data provider can both be supplied with the initial encryption key during setup of the system. In embodiments where the patient device is a general-purpose device such as a smart phone or tablet computer, the initial encryption key can be included in an application (“app”) that is downloaded and installed on the patient device to configure the patient device for use in the system.

Although in the present embodiment the patient device generates the encryption keys on-demand, in another embodiment the patient device is pre-configured with N predefined encryption keys, which have been generated in advance and installed in the patient device. For example, the predefined encryption keys can be included in an application (“app”) that is downloaded and installed on the patient device to configure the patient device for use in the system. The use of predefined encryption keys avoids the patient device having to be provided with the hash function and initial encryption key.

Then, in step S27, the patient device encrypts the token obtained in step S25, using the current encryption key obtained in step S26.

By generating each encryption key by hashing the previous encryption key, the token included in each instance of the data request information can be encrypted using a different key. This approach allows a data provider to determine whether any given data request information has been used previously to share data, as will be described in more detail later.

Next, in step S28, data request information is generated which includes both the access parameters obtained in step S24 and the encrypted token obtained in step S27. Then, in step S29 the data request information is provided to the physician device, for example by displaying the data request information.

Although in the present embodiment the current encryption key is only used to encrypt the data request token, in other embodiments other elements of the data request information may also be encrypted, for example the access parameters. When a link to the data provider, for example a URL, is included in the data request information, the URL is preferably left unencrypted so that it can be understood by the physician device. By leaving a URL unencrypted in the data request information, the physician device does not have to be provided with the initial encryption key, thereby improving security since the physician device is unable to access or modify information in the encrypted elements of the data request information. However, in some embodiments the physician device may also be provided with the initial encryption key, in which case the whole of the data request information, including a link to the data provider, can be encrypted by the patient device.

Also, in another embodiment stored access parameter information can be retrieved instead of generating user-defined access parameters in step S24. For example, default access parameters can be set and stored during configuration of the patient device.

Furthermore, in some embodiments, access parameter information may not be used and accordingly step S24 can be omitted. Also, some embodiments may not make use of single-use encryption aspect, in which case steps S26 and S27 can be omitted.

In another embodiment, the data request information is displayed as a QR code and the patient device is arranged to store a plurality of predetermined QR codes each including the data request information and any access parameter information if required. In this embodiment, step S26 can be omitted and instead of generating data request information on-demand in step S27, the device can simply select one of the predetermined QR codes that has not previously been used. For example, each code can be deleted from a list of available codes once it has been used, or can be flagged as unavailable. Because each predetermined QR code is used once, this embodiment can achieve the same effect as if single-use codes were used, without having to obtain a new code and generate new data request information on-demand every time.

Although in the present embodiment the patient device obtains a different encryption key each time, to enable the data provider to determine whether the data request information has already been used when receiving a data request from the physician device, in other embodiments an alternative approach may be used. For example, in another embodiment the patient device can be arranged to include a unique token in each instance of the data request information, and the data provider can maintain a record of tokens in received data requests to determine whether the currently-received token has been used previously. To ensure that the same token is not used twice by the patient device, the patient device could obtain each token from a list of predetermined tokens, and delete each token or otherwise flag each token as “used” once it has been used. Alternatively, the patient device could generate each token on-demand using a predetermined algorithm, while maintaining a record of previously-used tokens to determine whether the generated token has already been used. If so, the patient device can continue to generate new tokens until one is found which has not already been used. In this way, it can be ensured that each time the patient device generates new data request information to authorize a new request for access to medical data, a unique token can be included in the data request information for detection by the data provider.

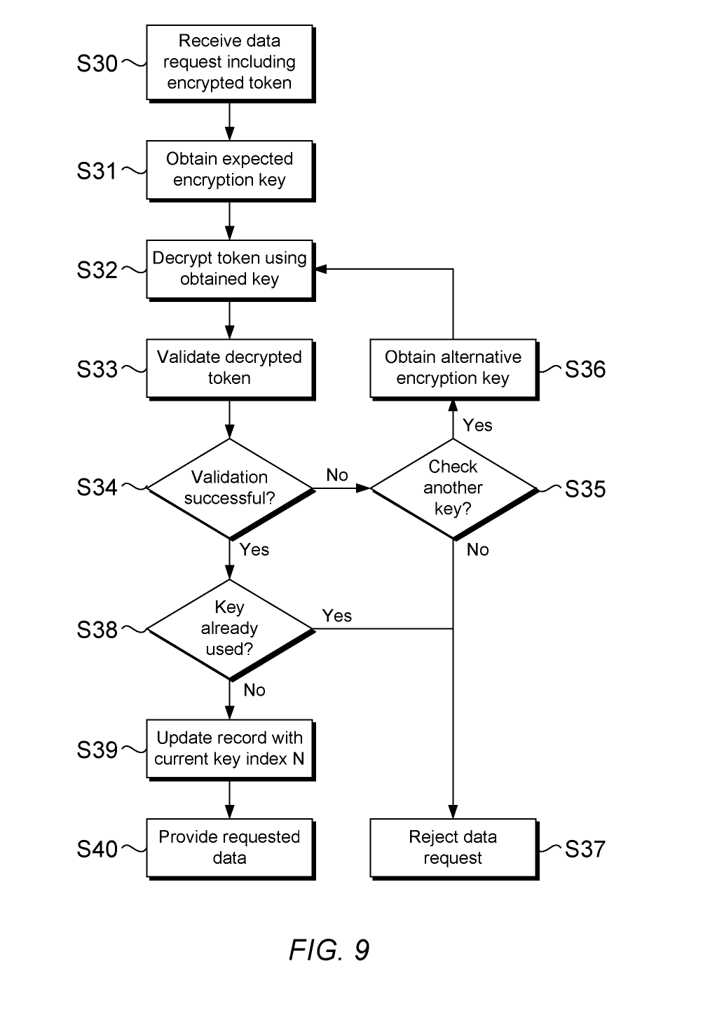

FIG. 9 shows a flow diagram explaining a method of managing access to medical data, according to an embodiment of the invention. The method can be used by a data provider to determine whether a received data request is based on old data request information that has already been used previously, to avoid a physician device being able to store data request information read from the patient device in order to gain access to the medical data again at a later point in time. The method of FIG. 9 can be used in embodiments where data request information has been generated using a method as described above with reference to FIG. 8.

First, in step S30 the data provider receives a data request from another device, such as any of the above-described physician devices. In the present embodiment, the physician device is arranged to transmit an encrypted token included in the data request information when requesting the medical data from the data provider.

Then, in step S31 the data provider obtains the expected encryption key (K_{N}) by applying the predetermined hash function to the previous encryption key (K_{N-1}), which is the key that was successfully used to decrypt the token from the most recently received data request. It will be appreciated that this approach requires both the patient device and the data provider to have access to the same predetermined hash function and initial encryption key.

Next, in step S32 the data provider decrypts the received token using the obtained key, and in step S33 the decrypted token is validated using a validation algorithm. In step S34, if the token was not successfully validated then in step S35 it is determined whether to check an alternative key. For example, it is possible that between the previous data request and the current data request being received by the data provider, a patient device has generated and displayed other data request information which, for whatever reason, has not been used. In this case, the token in the current data request will have been encrypted using a later encryption key than the one expected by the data provider.

Therefore in the present embodiment, if validation fails then the data provider proceeds to check alternative encryption keys by selecting an alternative key in step S36, for example by returning to the initial key (K₁) and attempting decryption and validation for each key in the chain until validation is successful, or until a predetermined limit is reached (e.g. time limit or number of keys checked). If the predetermined limit is reached, then at step S35 the process is terminated and the data request is refused in step S37.

On the other hand, if validation is successful in step S34, then in step S38 the data provider checks whether the key has already been used. In the present embodiment, the data provider maintains a record of the key indices (N) for any encryption keys that have already been used to encrypt received tokens, and compares the index (N) of the current encryption key (K_{N}) to the stored record to determine whether the N^{th} encryption key (K_{N}) has already been used.

If the current encryption key (K_{N}) has already been used, then in step S37 the data request is rejected. However, if the current encryption key (K_{N}) has not previously been used in a data request, then in step S39 the record is updated with the current key index N, and in step S40 the data request is allowed, and the requested data is provided to the physician device from which the request was received.

Although in the present embodiment the data provider determines whether or not to allow a data request on the basis of an encryption key used to encrypt a data request token, in other embodiments other approaches may be used. For example, as described above the patient device can include a unique code in each instance of the data request information, with or without encryption. In such embodiments, the data provider can maintain a record of all previously-received unique codes, and compare the current code to the stored record to determine whether the received unique code has already been included in a previous data request.

Methods such as the ones as described herein with reference to FIGS. 8 and 9 can be used to ensure that a physician device must obtain new data request information to regain access to the medical data, for example once the data access period permitted by previously-obtained data request information has expired, which gives a user of the patient device greater control over access to the medical data.

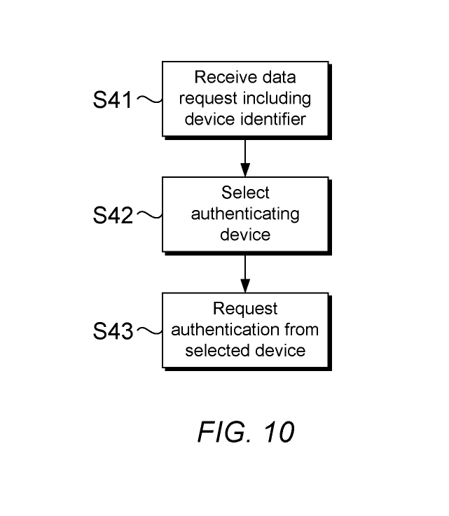

FIG. 10 shows a flow diagram explaining a method of selecting a device to perform authentication, according to an embodiment of the invention. The method can be used by a data provider in any of the above-described systems when authentication is required in order to authorize a data request, for example as described above with reference to FIGS. 4, 5 and 6.

First, in step S41 the data provider receives a data request including authenticating device information identifying the patient device or the physician device. The authenticating device information can, for example, be a unique device identifier assigned to the patient device or the physician device. Alternatively, the authenticating device information can be a flag whose value indicates which device an authentication request should be sent to. For example, a value of ‘0’ could indicate that the authentication request should be sent to the patient device, while a value of ‘1’ could indicate that the authentication request should be sent to the physician device.

In step S42, the data provider selects the authenticating device based on the received authenticating device information. Then, in step S43 the authentication request is transmitted to the selected device, in a similar manner to step S15 of FIG. 6.

Embodiments of the present invention have been described above in which a patient device provides data request information to a physician device in the form of a URL and a data request token. However, embodiments of the present invention are not limited to the use of tokens and URLs as data request information. For example, in another embodiment the data request information comprises a URL without a data request token, the URL linking directly to a directory on the data provider 130 through which the data can be accessed. This approach can enable a device to request the medical data by simply navigating to the URL, without the need for a data request token. Furthermore, in another embodiment the location of the data provider 130 may already be known to an entity requesting the medical data, meaning that a URL linking to the data provider 130 can be omitted from the data request information.

It will be appreciated that the term “comprising” does not exclude other elements or steps and that the indefinite article “a” or “an” does not exclude a plurality. A single processor may fulfill the functions of several items recited in the claims. The mere fact that certain measures are recited in mutually different dependent claims does not indicate that a combination of these measures cannot be used to an advantage. Any reference signs in the claims should not be construed as limiting the scope of the claims.

Although claims have been formulated in this application to particular combinations of features, it should be understood that the scope of the disclosure of the present invention also includes any novel features or any novel combinations of features disclosed herein either explicitly or implicitly or any generalization thereof, whether or not it relates to the same invention as presently claimed in any claim and whether or not it mitigates any or all of the same technical problems as does the parent invention. The applicants hereby give notice that new claims may be formulated to such features and/or combinations of features during the prosecution of the present application or of any further application derived therefrom.

1. A system for managing access to medical data corresponding to a patient, the system comprising:
a data provider arranged to provide access to the medical data;
a first module arranged to provide data request information for requesting access to the medical data from the data provider; and
a second module arranged to obtain the data request information from the first module, and to request access to the medical data from the data provider based on the obtained data request information,
characterized in that:
the first module is further arranged to include one or more access parameters in the data request information, the access parameters comprising parameters relating to how the medical data is to be shared with the second module;
the second module is further arranged to transmit the access parameters to the data provider when requesting access to the medical data;
wherein the data provider is arranged to respond to the request from the second module to access the medical data by requesting authentication of the patient to whom the requested medical data corresponds, and is arranged to provide access to the requested medical data to the second module in response to successful authentication, wherein the data provider is further arranged to control access to the medical data by the second module based on the access parameters.

2. (canceled)

3. The system of claim 1, wherein the one or more access parameters include:
a time period parameter defining a time period during which the second module is allowed to access the medical data; and/or
data element parameters identifying which ones of a plurality of data elements included in the medical data can be accessed by the second module.

4. The system of claim 1, wherein the data request information comprises a Uniform Resource Locator URL linking to the data provider, and the second module is arranged to request access to the medical data by navigating to the URL.

5. The system of claim 1, wherein the first module is arranged to display the data request information, and
wherein the second module is arranged to capture an image of the first module, and process the captured image to detect the displayed data request information.

6. The system of claim 1, wherein the data request information includes authenticating device information identifying the first module or the second module, and the data provider is arranged to request authentication from the first module or the second module identified by the authenticating device information, and/or
wherein the data provider is arranged to request authentication by transmitting an authentication request to the first module, receiving authentication information from the first module, and comparing the received authentication information to known authentication information for the patient to determine whether authentication is successful.

7. The system of claim 1, wherein after receiving the request for access to the medical data from the second module, the data provider is arranged to determine whether the data request information has already been used in a previous data request, and to only provide access to the requested medical data to the second module if it is determined that the data request information has not been used in a previous data request.

8. The system of claim 7, wherein the first module is arranged to obtain a protected token and include the protected token in the data request information, the protected token comprising a token that has been protected using a cryptographic key, and
wherein the data provider is arranged to receive the protected token from the second module, process the protected token using an expected cryptographic key, and if the token is successfully obtained using the expected cryptographic key, determine that the data request information has not been used in a previous data request if the expected cryptographic key has not previously been used.

9. The system of claim 8, wherein the data provider is arranged to obtain the expected cryptographic key by applying a cryptographic algorithm to a previous cryptographic key, which is a cryptographic key that was used in the most recently received data request prior to the current data request.

10. Apparatus for use as a first module in the system of claim 1, the apparatus comprising:
a data request information generator arranged to generate the data request information for requesting access to the medical data from the data provider; and
a data request information providing module arranged to provide the generated data request information to the second module.

11. A control method of the first module of claim 1, the method comprising:
generating the data request information for requesting access to the medical data from the data provider; and
providing the data request information to the second module.

12. Apparatus for use as a data provider in the system of claim 1, the apparatus comprising:
a controller arranged to retrieve the medical data corresponding to a patient;
an authentication module arranged to request authentication; and
a communication module arranged to communicate with the first module and the second module,
wherein in response to a request received through the communication module from the second module to provide access to the medical data, the controller is arranged to control the authentication module to request authentication from the first module through the communication module and determine whether authentication was successful, and in response to successful authentication the controller is arranged to provide access to the requested medical data to the second module through the communication module, wherein the controller is further arranged to control access to the medical data by the second module based on the access parameters.

13. A method of providing medical data, the method comprising:
receiving a request to provide access to the medical data;
requesting authentication from a first module or a second module, in response to the request for access to the medical data;
determining whether authentication was successful; the method being characterized in
providing access parameters for the request; and
in response to successful authentication, providing access to the requested medical data based on the provided access parameters.

14. Apparatus for use as a second module in the system of claim 1, the apparatus comprising:
a data request information detector arranged to obtain data request information from the first module;
a communication module for communicating with the data provider; and
a controller arranged to control the communication module to request access to the medical data from the data provider based on the obtained data request information.

15. The system of claim 5, wherein the first module is arranged to display the data request information in at least one of a Quick-Response (QR) code, a barcode or plain text.
